(19) United States
(12) Patent Application Publication
(10) Pub. No.: US 2012/0050250 A1
(43) Pub. Date: Mar. 1, 2012

(54) DISPLAY APPARATUS AND POWER CIRCUIT APPARATUS THEREOF

(75) Inventors: Sung-bum JUNG, Yongin-si (KR); Jin-hyung LEE, Anyang-si (KR)

(73) Assignee: SAMSUNG ELECTRONICS CO., LTD., Suwon-si (KR)

(21) Appl. No.: 13/013,934

(22) Filed: Jan. 26, 2011

(30) Foreign Application Priority Data
Aug. 27, 2010 (KR) 10-2010-0083412

(51) Int. Cl. G09G 5/00

(52) U.S. Cl. 345/212

(57) ABSTRACT

A display apparatus and a power circuit apparatus which supplies an operating voltage are provided. The power circuit apparatus includes a switch which is switched on and off to selectively supply an output voltage; a rectifying and smoothing unit which rectifies and smoothes the output voltage of the switch to supply an operating voltage for the display apparatus; a control circuit which controls the switch to make the operating voltage reach a target value; and a feedback unit which receives a bias current by the output voltage of the switch and supplies a feedback signal to the control circuit to prevent the operating voltage from exceeding a predetermined threshold value.

### CROSS-REFERENCE TO RELATED APPLICATION

This application claims priority from Korean Patent Application No. 10-2010-0083412, filed on Aug. 27, 2010 in the Korean Intellectual Property Office, the disclosure of which is incorporated herein by reference.

### BACKGROUND

1. Field

Apparatuses consistent with exemplary embodiments relate to a display apparatus and a power circuit apparatus thereof which supplies an operating voltage, and more particularly, to a display apparatus and a power circuit apparatus thereof which includes a feedback circuit to consume power to stabilize the operating voltage.

2. Description of the Related Art

A display apparatus such as a television (TV) includes a power circuit to supply an operating voltage to elements including a liquid crystal display (LCD) panel displaying a screen. The power circuit may include a feedback circuit to supply a feedback signal of the operating voltage to stabilize the operating voltage.

The feedback circuit may include a device such as a shunt regulator to supply a feedback signal. The device such as the shunt regulator receives a bias current to perform a normal operation. The size of the bias current may vary depending on circuits, e.g., approximately 1 mA or more.

The feedback circuit of a related art display apparatus consumes power due to the supply of the bias current, which results in power loss of the display apparatus.

Other than a normal mode in which the display apparatus operate normally, the display apparatus may further have a standby mode in which power supply to some of elements is cut off in certain circumstances to minimize power consumption. However, even in the standby mode, the feedback circuit of the display apparatus still needs to supply the bias current to continue to supply power to other elements. Considering more and more demand for less consumption of power in the standby mode, power consumption of the feedback circuit due to the bias current may become a serious issue.

### SUMMARY

One or more exemplary embodiments provide a display apparatus and a power circuit apparatus thereof which minimizes power consumption of a feedback circuit to stabilize an operating voltage.

According to an aspect of an exemplary embodiment, there is provided a power circuit apparatus for a display apparatus, the power circuit apparatus including: a switch which is switched on and off to selectively output an input voltage; a rectifying and smoothing unit which rectifies and smoothes an output voltage of the switch to supply an operating voltage for the display apparatus to perform its operation; a control circuit which controls the switch to make the operating voltage reach a predetermined target value; and a feedback unit which receives a bias current by the output voltage of the switch and supplies a feedback signal to the control circuit not to have the operating voltage exceed a predetermined threshold value.

The feedback unit may further include a light emitter of a photo coupler which is connected to an output terminal of the rectifying and smoothing unit; a shunt regulator which is connected to the light emitter of the photo coupler and is short-circuited for the light emitter of the photo coupler to emit light if the operating voltage exceeds the threshold value; and a light receiver of the photo coupler which supplies the feedback signal to the control circuit to inform that the operating voltage exceeds the threshold value if the light emitter of the photo coupler emits light.

The switch may include a transformer which includes a primary coil to receive the input voltage and a secondary coil which outputs the output voltage by converting the input voltage; and a switching device which is switched on and off to selectively flow a current to the primary coil of the transformer according to a control of the control circuit.

The output voltage may include a first output voltage which is output to the rectifying and smoothing unit and a second output voltage which is output to the feedback unit to supply the bias current, and the switch may include a transformer which includes a primary coil to receive the input voltage, a secondary main coil to output the first output voltage and a secondary auxiliary coil to output the second output voltage, and a switching device which is switched on and off to selectively flow a current to the primary coil of the transformer according to a control of the control circuit.

The feedback unit may further include a diode which rectifies the output voltage of the switch and supplies the bias current to the shunt regulator.

The feedback unit may further include a capacitor to remove a noise from the bias current.

According to an aspect of another exemplary embodiment, there is provided a display apparatus including: a signal receiver which receives an image signal; a signal processor which processes the image signal that is received by the signal receiver; a display unit which displays an image thereon based on the image signal that is processed by the signal processor; and a power circuit which supplies an operating voltage for the operation of the display unit, the power circuit including a switch which is switched on and off to selectively output an input voltage; a rectifying and smoothing unit which rectifies and smoothes an output voltage of the switch and supplies the operating voltage; a control circuit which controls the switch to make the operating voltage reach a predetermined target value; and a feedback unit which receives a bias current by the output voltage of the switch and supplies a feedback signal to the control circuit so that the operating voltage does not exceed a predetermined threshold value.

The feedback unit may further include a light emitter of a photo coupler which is connected to an output terminal of the rectifying and smoothing unit; a shunt regulator which is connected to the light emitter of the photo coupler and is short-circuited for the light emitter of the photo coupler to emit light if the operating voltage exceeds the threshold value; and a light receiver of the photo coupler which supplies the feedback signal to the control circuit to inform that the operating voltage exceeds the threshold value if the light emitter of the photo coupler emits light.

The switch may include a transformer which includes a primary coil to receive the input voltage, and a secondary coil to output the output voltage by converting the input voltage, and a switching device which is switched on and off to selectively flow a current to the primary coil of the transformer according to a control of the control circuit.

The output voltage may include a first output voltage which is output to the rectifying and smoothing unit, and a second output voltage which is output to the feedback unit to supply the bias current, and the switch may include a transformer which includes a primary coil to receive the input voltage, a secondary main coil to output the first output voltage by converting the input voltage and a secondary auxiliary coil to output the second output voltage, and a switching device which is switched on and off to selectively flow a current to the primary coil of the transformer according to a control of the control circuit.

The feedback unit may further include a diode which rectifies the output voltage of the switch and supplies the bias current to the shunt regulator.

The feedback unit may further include a capacitor to remove a noise from the bias current.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 is a circuit diagram of a power circuit of the display apparatus in FIG. 1 according to an exemplary embodiment;

FIG. 3 illustrates a waveform of a voltage to describe power consumption of a feedback unit in FIG. 2;

FIG. 4 is a circuit diagram of another power circuit of the display apparatus according to an exemplary embodiment; and

FIG. 5 illustrates a waveform of a voltage to describe power consumption of a feedback unit in FIG. 4.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

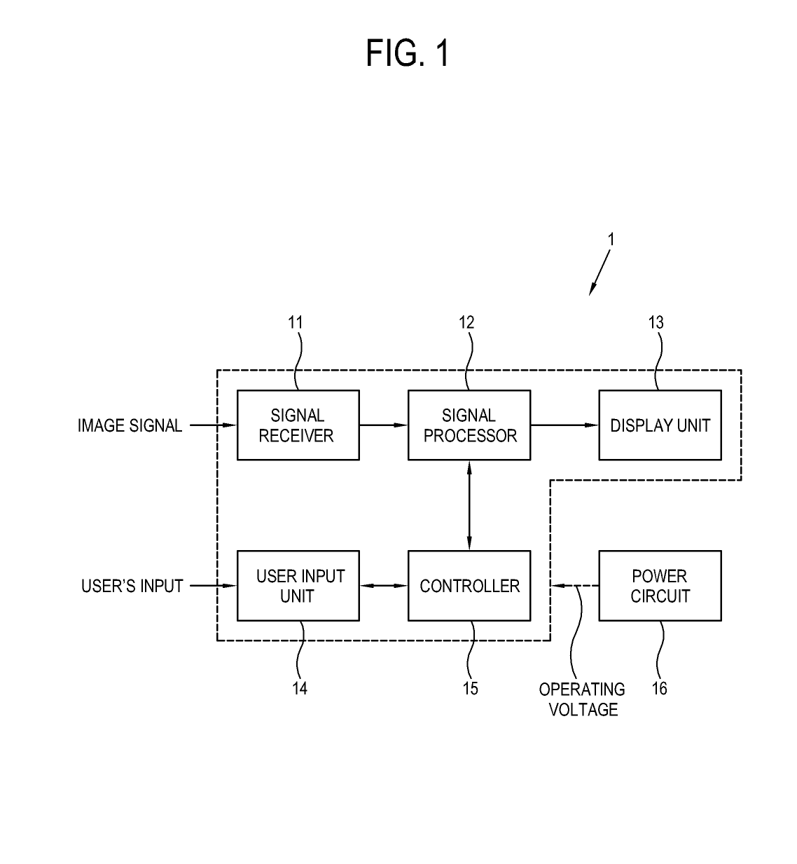

Hereinafter, a display apparatus according to an exemplary embodiment will be described in detail. FIG. 1 is a block diagram of a display apparatus 1 according to an exemplary embodiment. The display apparatus 1 may include a television (TV). The display apparatus 1 includes a signal receiver 11, a signal processor 12, a display unit 13, a user input unit 14 and a controller 15.

The signal receiver 11 receives an image signal including an image content. The image signal may further include an audio content and/or data content in addition to the image content. An image signal which is received by the signal receiver 11 includes a broadcasting signal transmitted by a broadcasting station, and a signal input from a predetermined image device. In the case of the broadcasting signal, the signal receiver 11 may selectively receive a broadcasting signal from one of a plurality of channels. The broadcasting signal includes a wireless broadcasting signal, a cable broadcasting signal, a satellite broadcasting signal and other known broadcasting signals. The type of the broadcasting signal includes a digital broadcasting signal and an analog broadcasting signal. The signal receiver 11 may process the received broadcasting signal to obtain an image content therefrom. The signal processing includes tuning, analog/digital conversion, demodulation and digital/analog conversion, but is not limited thereto.

In the case of an image signal input by an image device, the signal receiver 11 may communicate with the image device transmitting the image signal, corresponding to a property of the input image signal. Such communication includes wired and wireless communications, and analog and digital communications. The communication method includes all types of communications that are known to be used to transmit the image content. The image device which supplies an image signal to the signal receiver 11 is not limited in type, and includes a digital versatile disc (DVD) player, a Blu-ray disc (BD) player, a personal computer (PC), a mobile phone, a smartphone and other TVs. The signal receiver 11 may process the input image signal to obtain an image content therefrom. The processing may include an analog-digital conversion and a digital-analog conversion.

Further, the signal receiver 11 may receive an image signal from a predetermined server through a network or an image signal from a portable storage device such as a universal serial bus (USB) storage medium. In each of the above cases, the signal receiver 11 may communicate with a counterpart device in a given manner to receive an image signal. In any case, the signal receiver 11 may receive and process the image signal according to a control of the controller 15.

The signal processor 12 processes an image content that is obtained from the image signal received by the signal receiver 11 to display the image content. The image processing includes demultiplexing, decoding and scaling an image, and adjusting and improving a picture quality, but is not limited thereto. The signal processor 12 may process an image relating to a user interface (UI) menu for an interface with a user. The signal processor 12 may overlap at least a part of an image of the image content and an image relating to the UI menu or arrange image by image.

The display unit 13 displays thereon an image processed by the signal processor 12. The method of displaying the image by the display unit 13 is not limited, and includes all of known display methods. The display unit 13 may include a liquid crystal display (LCD) panel, an organic light emitting diode (OLED) panel, a plasma display panel (PDP), a projection or a cathode ray tube (CRT), but is not limited thereto.

The user input unit 14 receives a user's command, and may include a remote controller, a manipulation panel, etc.

The controller 15 controls the display main body 1 as a whole. The controller 15 controls elements of the display apparatus 1 according to user's command input from the user input 14. The controller 15 may control the signal receiver 11 to receive a desired image signal. The controller 15 may control the signal processor 12 to process the image content obtained from the image signal received by the signal receiver 11 and/or the UI menu. The controller 15 may store data in a storage unit such as a flash memory or a hard disc drive (HDD) or read the data stored in the storage unit as necessary for the above control.

The controller 15 may include a non-volatile memory to store therein an execution code of a computer program corresponding to the foregoing control, a volatile memory to load at least a part of the execution code stored in the non-volatile memory, and a microprocessor to execute the execution code loaded to the volatile memory.

The display apparatus 1 further includes a power circuit 16 to supply power (hereinafter, to be also called “operating voltage”) to the elements of the display apparatus. FIG. 1 illustrates a simple supply route of the operating voltage of the power circuit 16 for convenience. The power circuit 16 may include, e.g., at least one printed circuit board (PCB) having a circuit device built therein. The power circuit 16 may be provided within the display apparatus 1 together with other elements. According to another exemplary embodiment, the power circuit 16 may be provided as an additional device which is separated from other elements of the display apparatus 1 and connected thereto.

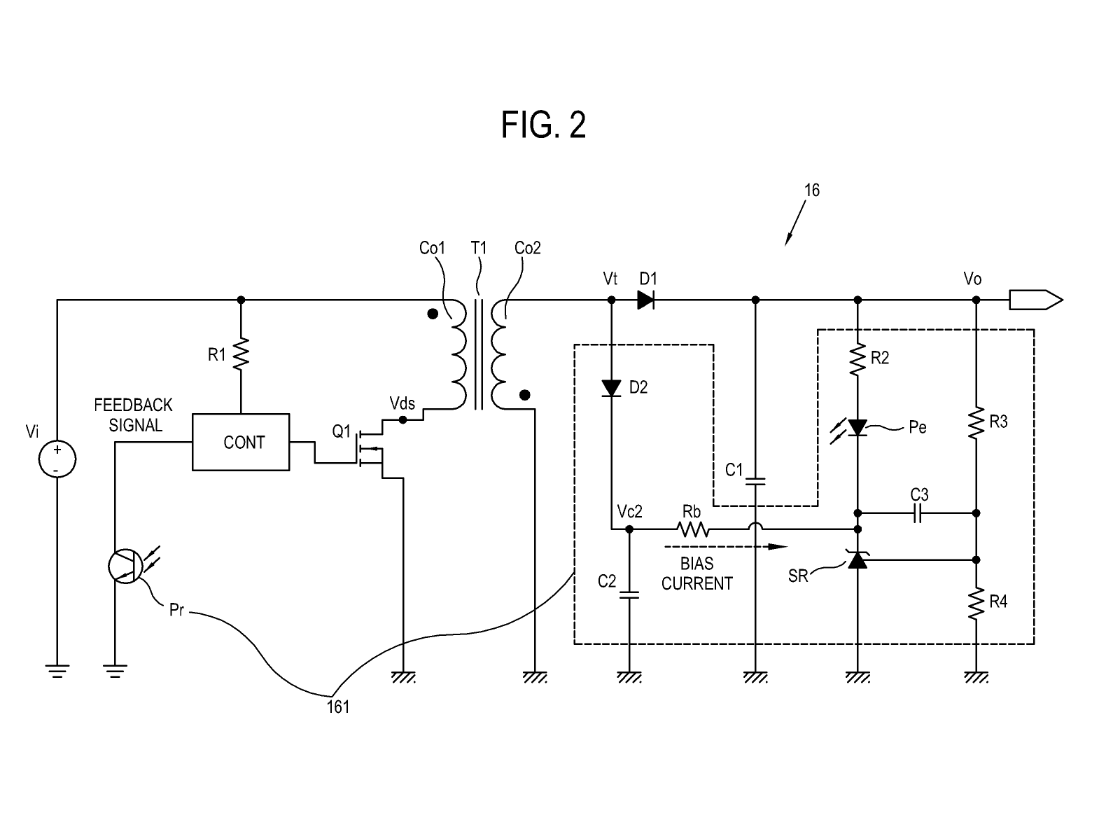

FIG. 2 is a circuit diagram of the power circuit 16 of the display apparatus 1 in FIG. 1. The power circuit 16 in FIG. 2 may include a switch T1 and Q1, a rectifying and smoothing unit D1 and C1, a control circuit CONT and a feedback unit 161.

The switch T1 and Q1 outputs an output voltage Vt which is converted from an input voltage Vi. A transformer T1 of the switch T1 and Q1 includes a primary coil Co1 which is connected to the input voltage Vi, and a secondary coil Co2 which is connected to the output voltage Vt. A switching device T1 of the switch T1 and Q1 is connected in series to the primary coil Co1, and is switched on and off by a control of the control circuit CONT. The switching device T1 may include a field effect transistor (FET). If the switching device T1 is turned on, a current flows to the primary coil Co1. If the switching device T1 is turned off, a current does not flow to the primary coil Co1. If there is any change in the current flowing in the primary coil Co1, a corresponding output voltage Vt is induced in the secondary coil Co2.

A first diode D1 of the rectifying and smoothing unit D1 and C1 rectifies the output voltage Vt induced in the secondary coil Co2 of the switch T1 and Q1. A first capacitor C1 of the rectifying and smoothing unit D1 and C1 smoothes the voltage rectified by the first diode D1 and supplies an operating voltage Vo.

The control circuit CONT controls the switch T1 and Q1 to have the operating voltage Vo become a predetermined target value. The target value of the operating voltage Vo may vary based on the design of the circuit, in consideration of the property of the display apparatus 1. For example, the target value of the operating voltage Vo may be set as 5V, but is not limited thereto. The control circuit CONT has a pulse width modulation (PWM) control to control the switch T1 and Q1. The power circuit 16 may further include a first resistor R1 which is provided between the control circuit CONT and the input voltage Vi to detect the input voltage Vi.

The feedback unit 161 may include a light emitter Pe of a photo coupler which is connected to the operating voltage Vo through a second resistor R2. The light emitter Pe emits light when a current flowing in the light emitter Pe is a predetermined value or more. The feedback unit 161 may further include a shunt regulator SR which detects a level of the operating voltage Vo through a third resistor R3 and a fourth resistor R4 and is short-circuited if the operating voltage Vo reaches a predetermined threshold value. A first end of the shunt regulator SR is connected to the light emitter Pe and a second end thereof is grounded. If the shunt regulator SR is open, a current does not flow to the light emitter Pe substantially. If the shunt regulator SR is short-circuited, the current flows to the light emitter Pe through the shunt regulator SR.

The feedback unit 161 may further include a light receiver Pr of the photo coupler which is switched on and off by the light emission of the light emitter Pe and supplies a feedback signal of the operating voltage Vo to the control circuit CONT. The light receiver Pr is turned on when the light emitter Pe emits light, and supplies a feedback signal to indicate that the operating voltage Vo has reached the predetermined threshold value. The control circuit CONT controls the switch T1 and Q1 so that the operating voltage Vo does not exceed the predetermined threshold value according to a feedback signal. The threshold value of the operating voltage Vo may be the same or a little higher than the target value.

The shunt regulator SR may include an integrated circuit (IC) which is also called an error amplifier. The shunt regulator SR needs to receive a bias current to perform its operation. To do the foregoing, the feedback unit 161 may further include a second diode D2, a second capacitor C2 and a bias resistor Rb. An anode of the second diode D2 may be connected to the output voltage Vt and a cathode may be connected to a first end of the second capacitor C2. A second end of the second capacitor C2 is grounded. A first end of the bias resistor Rb is connected to the first end of the second capacitor C2 and a second end thereof is connected to a first end of the shunt regulator SR. The shunt regulator SR receives the bias current by the output voltage Vt through the second diode D2 and the bias resistor Rb to perform its operation. The second capacitor C2 is used to reduce noise which may occur from the bias current.

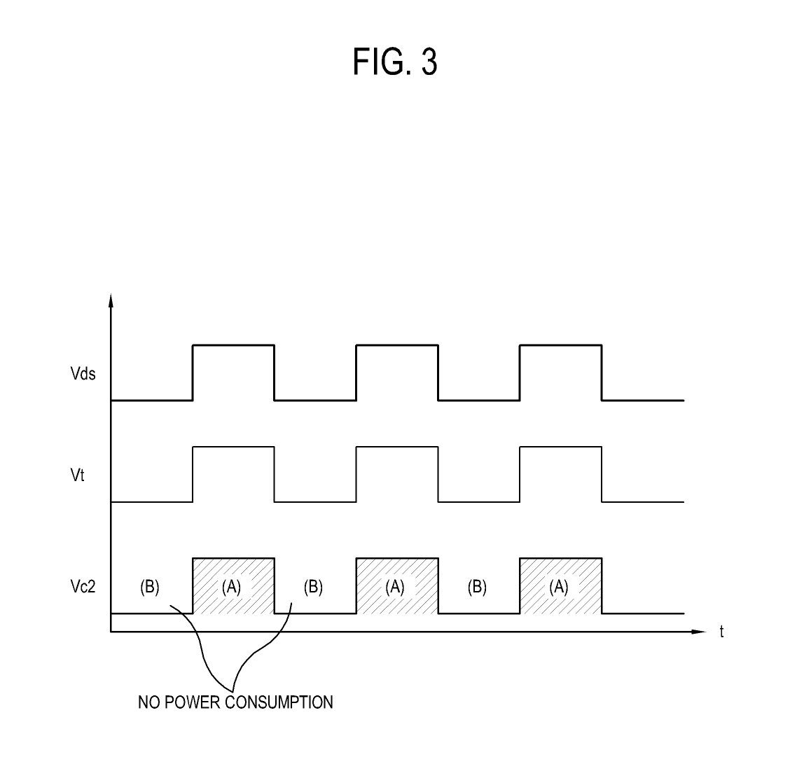

FIG. 3 illustrates a waveform of a voltage to describe a power consumption of the feedback unit 161 in FIG. 2. In FIG. 3, “Vds” refers to a switching voltage applied to opposite ends of the switching device Q1, “Vt” refers to an output voltage induced in the secondary coil Co2 of the transformer T1, and “Vc2” refers to a voltage applied to the second capacitor C2. The switching voltage Vds and the output voltage Vt have a square wave by a PWM control of the control circuit CONT. The second capacitor C2 is set to be small in capacitance so that the voltage Vc2 thereof has a square wave like the switching voltage Vds and the output voltage Vt.

Power consumption of the bias resistor Rb to supply a bias current occurs only in areas where the voltage Vc2 of the second capacitor C2 is indicated as “(A)” in FIG. 3. That is, power consumption due to the supply of the bias current does not occur in areas where the voltage Vc2 of the second capacitor C2 is indicated as “(B)” in FIG. 3, and power loss of the display apparatus 1 may be minimized. The less the voltage of Vc2 of the second capacitor C2 is, the further the power consumption to supply the bias current may be reduced. According to the present exemplary embodiment, the bias current is supplied by the first capacitor C1 which has a larger capacitance (e.g. several tens of [uF]), and the second capacitor C2 which has a smaller capacitance (e.g., [pF] or [nF]), and the display apparatus 1 may be designed to consume less power.

The feedback unit 161 may further include a third capacitor C3 which connects a first end of the shunt regulator SR and a point between the third resistor R3 and the fourth resistor R4.

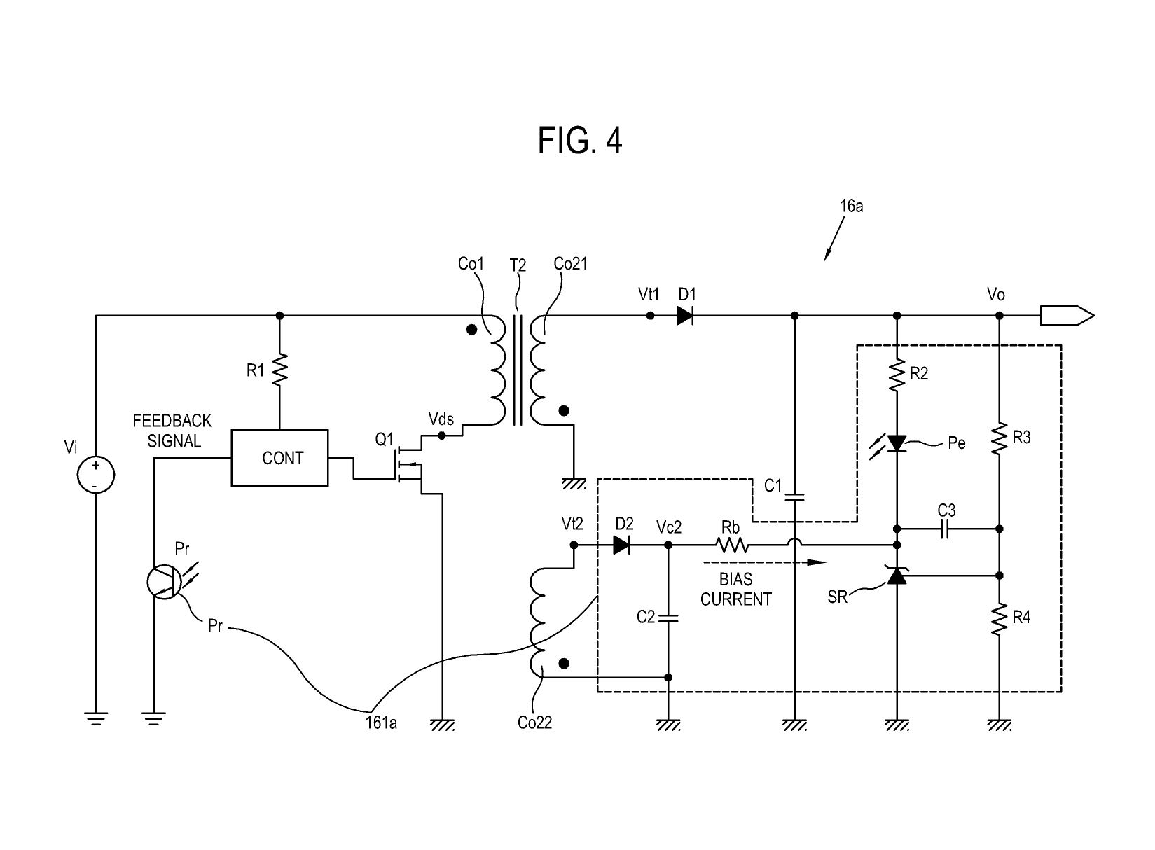

FIG. 4 is a circuit diagram of another power circuit of the display apparatus 1 according to an exemplary embodiment. The power circuit 16 of the display apparatus 1 in FIG. 1 may be replaced by a power circuit 16a in FIG. 4. The description of the configuration of the power circuit 16a in FIG. 4 which is the same or similar to that of the power circuit 16 in FIG. 2 will be omitted.

The power circuit 16a includes a feedback unit 161a to supply a feedback signal of an operating voltage Vo. To supply a bias current to a shunt regulator SR of the feedback unit 161a, a transformer T2 of a switch T2 and Q1 of the power circuit 16a includes a secondary main coil Co21 to output a first output voltage Vt1 and a secondary auxiliary coil Co22 to output a second output voltage Vt2. An anode of the second diode D2 of the feedback unit 161a is connected to a second output voltage Vt2 of the secondary auxiliary coil Co22. The secondary auxiliary coil Co22 has a wiring set to make the second output voltage Vt2 smaller than the first output voltage Vt1. The second output voltage Vt2 according to the present exemplary embodiment may be set as a minimum voltage to bias the shunt regulator SR.

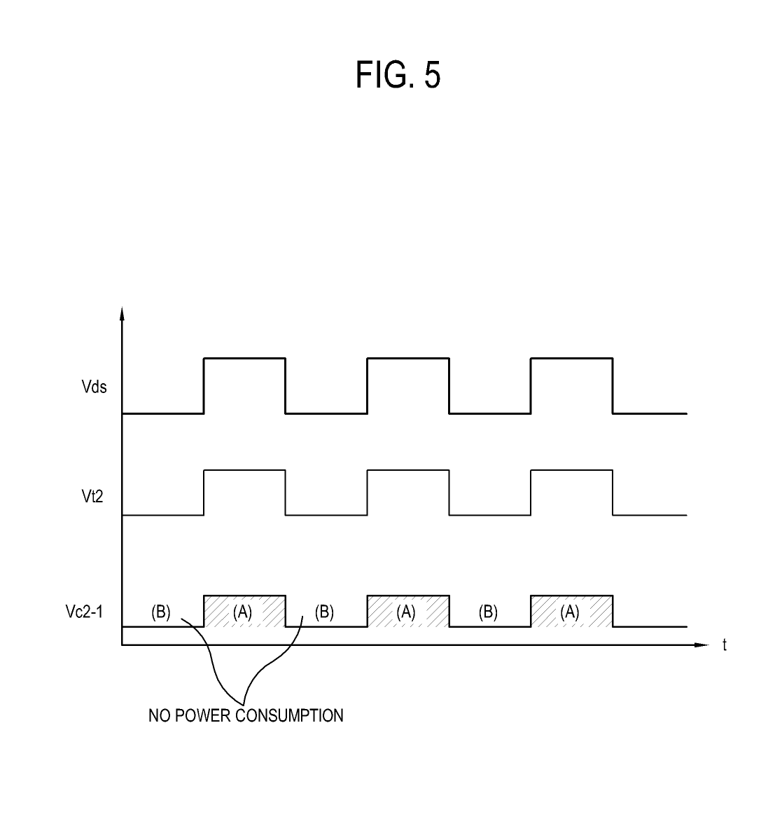

FIG. 5 illustrates a waveform of a voltage to describe a power consumption of the feedback unit 161a in FIG. 4. In FIG. 5, “Vds” refers to a switching voltage applied to opposite ends of the switching device Q1, “Vt2” refers to a second output voltage induced in the secondary auxiliary coil Co22 of the transformer T2, and “Vc2-1” refers to a voltage applied to the second capacitor C2. The voltage Vc2-1 of the second capacitor C2 in FIG. 5 is relatively smaller than the voltage Vc2 of the second capacitor C2 in FIG. 3. According to the present exemplary embodiment, power consumption of the bias resistor Rb to supply the bias current may be further reduced.

As described above, a display apparatus and a power circuit apparatus thereof according to an exemplary embodiment minimizes power consumption of a feedback circuit to stabilize an operating voltage, and among others, meets demand for reducing power consumption in a standby mode.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A power circuit apparatus for a display apparatus, the power circuit apparatus comprising:
a switch which is switched on and off to selectively supply an output voltage;
a rectifying and smoothing unit which rectifies and smoothes the output voltage of the switch to supply an operating voltage for operating the display apparatus;
a control circuit which controls the switch to make the operating voltage reach a target value; and
a feedback unit which receives a bias current by the output voltage of the switch and supplies a feedback signal to the control circuit to prevent the operating voltage from exceeding a threshold value.

2. The power circuit apparatus according to claim 1, wherein the feedback unit comprises a light emitter of a photo coupler which is connected to an output terminal of the rectifying and smoothing unit;
a shunt regulator which is connected to the light emitter of the photo coupler and is short-circuited for the light emitter of the photo coupler to emit light if the operating voltage exceeds the threshold value; and
a light receiver of the photo coupler which supplies the feedback signal to the control circuit to indicate that the operating voltage exceeds the threshold value if the light emitter of the photo coupler emits light.

3. The power circuit apparatus according to claim 2, wherein the switch comprises a transformer which comprises a primary coil which receives an input voltage and a secondary coil which outputs the output voltage by converting the input voltage; and
a switching device which is switched on and off to selectively provide a current to the primary coil of the transformer according to a control of the control circuit.

4. The power circuit apparatus according to claim 2, wherein the output voltage comprises a first output voltage which is output to the rectifying and smoothing unit and a second output voltage which is output to the feedback unit to supply the bias current, and
wherein the switch comprises:
a transformer which comprises a primary coil which receives an input voltage, a secondary main coil which outputs the first output voltage and a secondary auxiliary coil which outputs the second output voltage; and
a switching device which is switched on and off to selectively supply a current to the primary coil of the transformer according to a control of the control circuit.

5. The power circuit apparatus according to claim 2, wherein the feedback unit further comprises a diode which rectifies the output voltage of the switch and supplies the bias current to the shunt regulator.

6. The power circuit apparatus according to claim 2, wherein the feedback unit further comprises a capacitor which removes noise from the bias current.

7. A display apparatus comprising:
a signal receiver which receives an image signal;
a signal processor which processes the received image signal;
a display unit which displays an image based on the processed image signal; and
a power circuit which supplies an operating voltage for the operation of the display unit,
wherein the power circuit comprises:
a switch which is switched on and off to selectively supply an output voltage;
a rectifying and smoothing unit which rectifies and smoothes the output voltage of the switch and supplies the operating voltage;
a control circuit which controls the switch to make the operating voltage reach a target value; and
a feedback unit which receives a bias current by the output voltage of the switch and supplies a feedback signal to the control circuit to prevent the operating voltage from exceeding a threshold value.

8. The display apparatus according to claim 7, wherein the feedback unit comprises a light emitter of a photo coupler which is connected to an output terminal of the rectifying and smoothing unit;
a shunt regulator which is connected to the light emitter of the photo coupler and is short-circuited for the light emitter of the photo coupler to emit light if the operating voltage exceeds the threshold value; and
a light receiver of the photo coupler which supplies the feedback signal to the control circuit to indicate that the operating voltage exceeds the threshold value if the light emitter of the photo coupler emits light.

9. The display apparatus according to claim 8, wherein the switch comprises a transformer which comprises a primary coil which receives an input voltage, and a secondary coil which outputs the output voltage by converting the input voltage, and a switching device which is switched on and off to selectively flow a current to the primary coil of the transformer according to a control of the control circuit.

10. The display apparatus according to claim 8, wherein the output voltage comprises a first output voltage which is output to the rectifying and smoothing unit, and a second output voltage which is output to the feedback unit to supply the bias current, and
the switch comprises a transformer which comprises a primary coil which receives an input voltage, a secondary main coil which outputs the first output voltage by converting the input voltage and a secondary auxiliary coil to output the second output voltage, and a switching device which is switched on and off to selectively flow a current to the primary coil of the transformer according to a control of the control circuit.

11. The display apparatus according to claim 8, wherein the feedback unit further comprises a diode which rectifies the output voltage of the switch and supplies the bias current to the shunt regulator.

12. The display apparatus according to claim 8, wherein the feedback unit further comprises a capacitor which removes noise from the bias current.
